(19) United States
(12) Patent Application Publication
(10) Pub. No.: US 2014/0131325 A1
(43) Pub. Date: May 15, 2014

(54) Method to plasma arc weld and full-position pipe weld

(71) Applicants: YuMing Zhang, Nicholasville, KY (US); Xiangrong Li, Peabody, MA (US); Zeng Shao, Lexington, KY (US)

(72) Inventors: YuMing Zhang, Nicholasville, KY (US); Xiangrong Li, Peabody, MA (US); Zeng Shao, Lexington, KY (US)

(73) Assignee: Adaptive Intelligent Systems LLC

(21) Appl. No.: 13/694,229

(22) Filed: Nov. 13, 2012

(51) Int. Cl. B23K 10/02; B23K 9/12; H05H 1/48

(52) U.S. Cl. CPC B23K 10/02; H05H 1/48; B23K 9/125
USPC 219/121.46; 219/121.54; 219/130.31; 219/137.7

(57) ABSTRACT

This invention is to plasma arc weld using a keyhole mode to build a partially-penetrated keyhole and then a melt-in mode to finally reach the full penetration before switching to the base period. The full penetration is thus established during the peak period in two stages: keyhole stage and then melt-in stage. While the keyhole stage helps reduce the heat inputs and weld puddles, the melt-in stage finishes the full penetration at reduced impacts from the plasma jets producing the desired weld bead geometry and regularity. The duration of the melt-in stage is automatically determined using arc signals to assure the full penetration. In comparison with keyhole PAW, bead geometry and regularity are significantly improved with slightly increased net heat inputs. In comparison with melt-in PAW and GTAW, the net heat input is reduced approximately forty percent.

### GOVERNMENT INTEREST STATEMENT

The present invention was made with government support under agreement KSTC-184-512-08-048 as the matching fund from the Kentucky Cabinet for Economic Development (CED) Office of Commercialization and Innovation for contract N00024-08-C-4111 awarded by the Department of the Navy. The government has certain rights in the invention.

### FIELD OF THE INVENTION

This invention relates to arc welding, and more particularly to plasma arc welding and its variants.

### BACKGROUND

Plasma arc welding (PAW) introduced by Gage in 1957 [1] offers certain advantages. As an extension of gas tungsten arc welding (GTAW), PAW uses a constricting nozzle/orifice to create a plasma arc that has a higher heat density. This increased heat density not only provides higher arc temperatures but also a much stronger arc force. In general, its most widely used configuration is the transferred arc PAW, in which the plasma arc is formed between the tungsten electrode and work-piece as shown in FIG. 1. Its welding current is generally set to be DCEN (Direct Current Electrode Negative) in order to provide better control of the energy release [2]. In addition, since the plasma arc is highly constricted compared with electrical arcs in GTAW process, the arc length has an excellent linear relationship with the arc voltage under the same welding current. As a result, a measurement of arc voltage may indicate the arc length more accurately to better reflect the penetration.

The transferred arc PAW process typically operates in either keyhole or melt-in (conduction) mode [3]. The special torch used in PAW has a constraining orifice [4] designed to deliver a highly constrained plasma jet. Keyhole mode can obtain much deeper penetration compared with other arc welding processes. In this mode, the plasma jet melts the work-piece and displaces the molten metal to form a keyhole or deep narrow cavity [5]. By doing this, the plasma jet is able to heat the work-piece through the whole thickness, giving keyhole PAW high penetration capability [6]. On the other hand, melt-in mode, with reduced penetration capability, is suitable for joining thin sections (0.025-1.5mm or 0.001-0.060 inch), making fine welds at low currents, and joining thicker sections (up to 3 mm or 0.125 inch) at high currents. The operation of melt-in mode is similar to that of GTAW process.

Repeated experiments show that weld beads made by keyhole PAW typically have relatively large and irregular ID (inner diameter) reinforcements associated with considerable amount of spatters. On the other hand, those made by melt-in PAW show large ID weld beads that may cause excessive convexity around 12 o'clock and concavity around 6 o'clock. To resolve these issues, the double stage PAW method is invented to combine keyhole and melt-in mode into a single welding procedure.

### SUMMARY OF THE INVENTION

The method of the present invention to plasma arc weld uses a controlled plasma arc welding system as shown in FIG. 2 which at least includes: (1) a plasma arc welding power supply 211 or an equivalent; (2) a plasma arc welding torch 222 or an equivalent; (3) a device to measure the plasma arc voltage 221; (4) a computer 203 or equivalent with necessary accessories to read the measured arc voltage 221, to process the measured arc voltage 221 and send the control parameter signals 220 to control the output amperage of the plasma arc welding power supply 211; and (5) the computer accessories that include but not limited to the input isolation modules 204 and output isolation amplified modules 201.

The method of the present invention is to use this controlled plasma arc welding system to first apply a relatively high plasma arc current, that is high enough to establish a keyhole on the work-piece being welded if the application time is sufficiently long, for an appropriate period without establishing a full penetration; then apply the plasma arc current at a reduced level that is not sufficient to establish a keyhole through the work-piece; then process the plasma arc voltage measurements to determine if the criterion for the full penetration establishment has been met; then further reduce the amperage of the plasma arc current to start the base period. The criterion for the establishment of the full penetration constitutes another key of this invention and will be discussed further.

An embodiment of the controlled plasma arc welding system is illustrated in FIG. 3. The computer 203 is now an embedded system 303. The plasma arc welding torch 312 is a Thermal Arc PWH-3A plasma welding torch. The power supply 311 is in constant current (CC) mode and operated in DCEN. The torch is water-cooled by the coolant recirculator inside the power supply. Pure Argon is used as the shielding gas, plasma gas, as well as backside purging gas for the pipe in case a pipe is welded. The torch can be carried by a motion system, either a welding robot or any other mechanical motion systems.

### BRIEF DESCRIPTION OF THE DRAWINGS

FIG. 1 (Prior Art) shows the principle of the conventional plasma arc welding known to one of ordinary in the art.

FIG. 2 (This Invention) shows the principle of the system for the controlled plasma arc welding in this invention.

FIG. 3 (This Invention) illustrates a specific system for the controlled plasma arc welding in this invention.

FIG. 4 (This Invention) uses the current and voltage waveforms to illustrate the principle of the double-stage plasma arc welding in this invention.

FIG. 5 (This Invention) gives a specific flow chart of a specific control algorithm to further illustrate the principle of the double-stage plasma arc in this invention.

FIG. 6 (This Invention) shows a specific system for the controlled plasma welding when an optional filler is added in this invention.

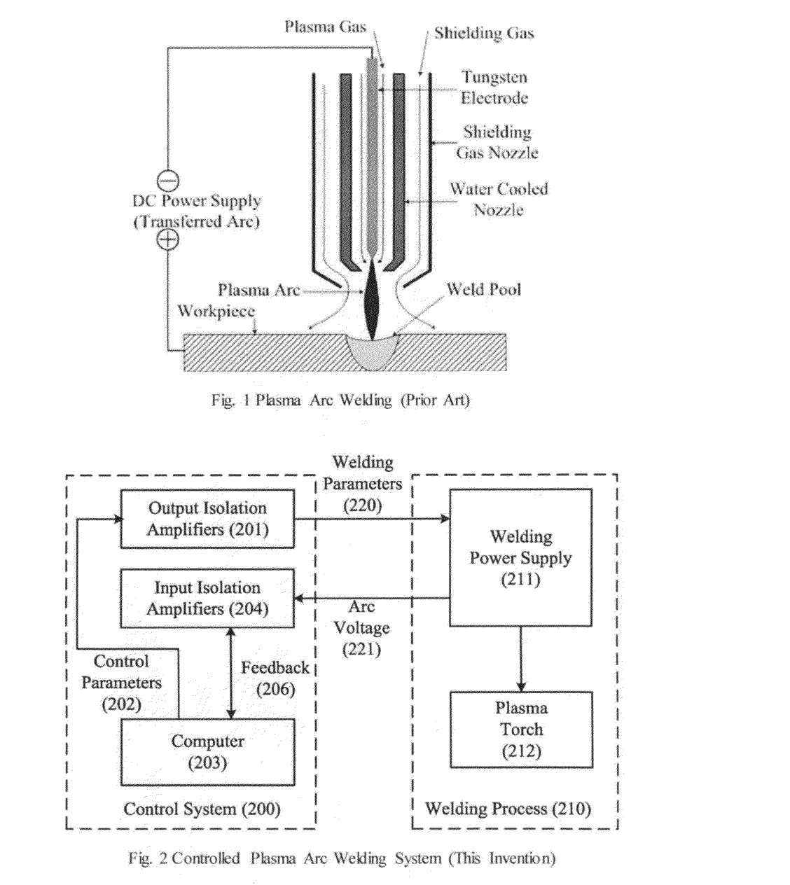

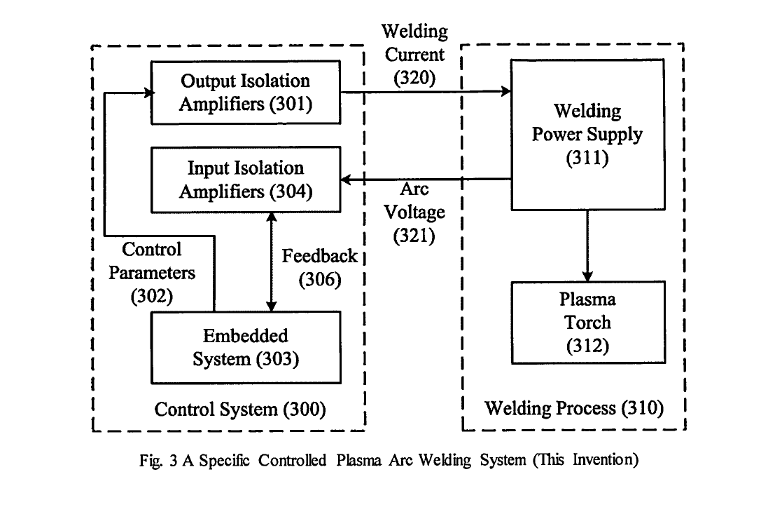

### DETAILED DESCRIPTION OF THE INVENTION

### Double Peak Stage Procedure

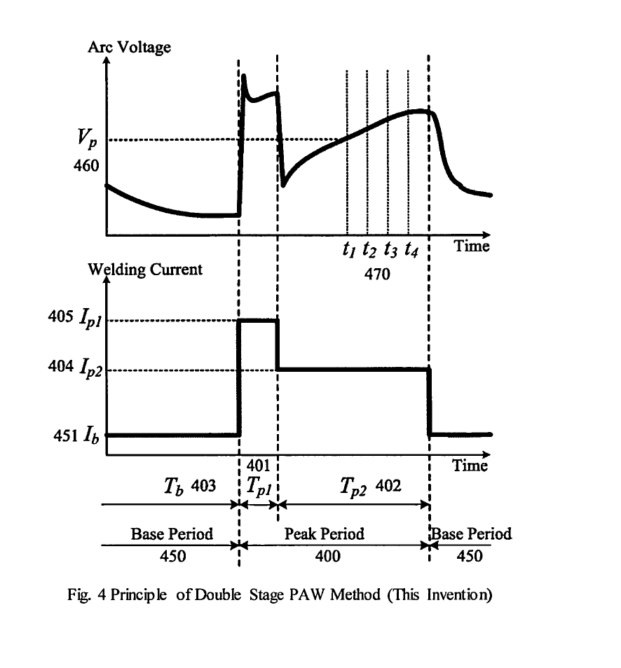

FIG. 4 shows the principle of the double peak stage procedure that characterizes the present invention. The method of this invention for plasma arc welding (PAW) also has two periods, peak period 400 and base period 450, similarly as in conventional PAW of the prior art. However, this invention divides the peak period 400 into the first stage 401 and second stage 402 with the current in the first stage, i.e., Iₚ₁ 403, significantly greater than that in the second stage, i.e., Iₚ₂ 404.

The first stage is to use a keyhole mode type of operation to penetrate the work-piece rapidly. However, this stage stops before the keyhole fully penetrates to the backside of the work-piece in order to prevent the problems in a normal keyhole mode aforementioned. Then a melt-in mode type of operation follows as the second stage to continue and finish the establishment of full penetration but in a smoother and slower manner with a much lower penetration capability. The weaker penetration capability similar as in a GTA can produce smooth full penetration welds eliminating the geometrical irregularities. That is, the first stage achieves a penetration depth with a minimal heat input and the second stage finishes the full penetration establishment process using an arc similar to a GTA. Smooth and relative narrow welds may thus be produced in the second peak stage. The base period further reduces the heat input to freeze the liquid metal before the next peak period begins.

FIG. 4 uses reducing the peak current from Iₚ₁ to Iₚ₂ as an example to reduce the penetration capability. While reducing the current is an effective method to reduce the penetration capability to switch from the keyhole to melt-in mode, the essence of this invention is to switch from the keyhole to melt-in mode before the work-pieces is fully penetrated. Hence, this invention does not exclude the use of other means to change the penetration capability for PAW including but not limited to (1) changing the actual flow rate of the plasma gas to switch from the first stage 401 to the second stage 402; (2) changing the effective diameter of the orifice where the plasma gas exits from the plasma torch; (3) using any electrical, magnetic, and/or mechanical ways to change the distribution of the plasma arc to change its penetration capability; (4) using any ways to change the setback of the electrode.

### Adaptive Second Peak Stage

In conventional PAW of the prior art, the amperages of the peak current and base current and their durations are programmed based on the applications. In this invention, the amperage during the first stage in the peak period and its duration and the amperage during the second stage, i.e., Iₚ₁ 403, Tₚ₁ 401, and Iₚ₂ 404, are pre-programmed but the duration of the second peak, i.e., Tₚ₂ 402 is determined using the arc voltage 460. Further, the determination is made using the slope of the arc voltage 460 and the criterion to end the second peak period 402 to switch to the base current period 450 is to judge if the positive slope of the arc voltage has become below a sufficiently small positive number ε≧0. In addition, because the arc voltage measurements are noisy, the slope of the arc voltage needs to be determined using filtered arc voltage signal. The filtering of the arc voltage requires consecutive measurements made at consecutive sampling instants such as t₁, t₂, . . . t₄ 470.

### An Example

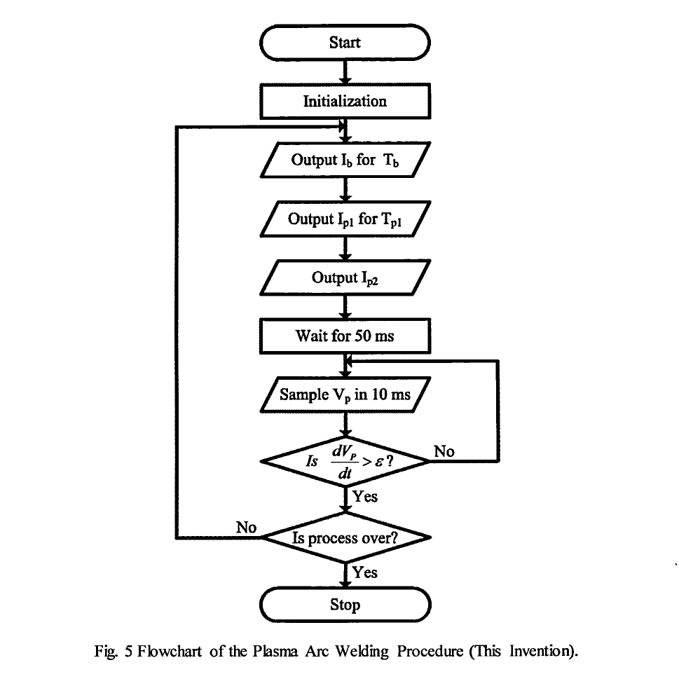

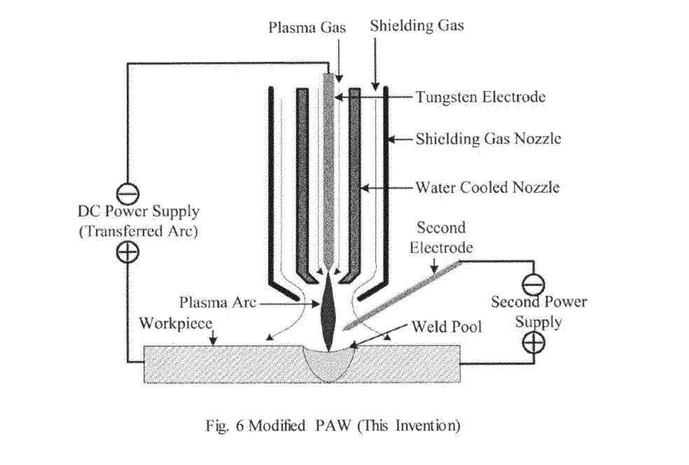

A detailed example procedure to realize the PAW method of this invention can be given below with reference to FIG. 4 and FIG. 5:
(1) Initialization of process, including welding parameters and control parameters;

(2) Output the base current I_{b} 451 for the base period T_{b} 450;

(3) Output the first peak current Iₚ₁ 403 for the first peak period Tₚ₁ 401. Both Iₚ₁ 403 and Tₚ₁ 401 are empirically determined;

(4) Switch to the second peak current Iₚ₂ 404 and then wait for a short period (typically less than 50 ms);

(5) Sample the arc voltage and calculate an average each 10 ms as a sampled arc voltage measurement Vₚ 460;
(6) For each four consecutive Vₚ measurements (e.g. at t₁, t₂, t₃, t₄), a linear model is fitted by the least squares method; extension can be easily to more consecutive measurements higher order models;
(7) The slope of the fitted curve, dVₚ/dt, is then computed from the model and compared with a pre-determined criterion threshold ε≧0. If dVₚ/dt>ε, it is judged that the desired penetration is not reached. If this is the case, the control program goes to step (5); otherwise, to step (2) to start the next control pulse period.

### Mode Switch

If the welding is performed using a single (either keyhole or melt-in) mode, the plasma torch configuration and welding conditions can be set-up in advance and then be kept unchanged during the entire welding process. However, for this invention, the PAW process needs to switch from keyhole to melt-in operation mode in real-time. The challenge here is how to switch from keyhole to melt-in mode with a torch configured for keyhole mode. This question can be simplified as how to reduce penetration capability of plasma arc during welding operation. To find an acceptable solution, several key factors affecting penetration capability should be considered.

The physical configuration of plasma torch is one of the most important factors in determining penetration capability. Smaller orifice diameter can provide better mechanical constriction. Larger electrode setback can achieve similar effects. However, during welding operation, it is not practical to change any of them. Hence, the torch configuration is so determined that the penetration capability is just sufficient for keyhole operation.

The plasma gas flow rate is another key factor determining the penetration capability. PAW process is sensitive to this parameter. A simple adjustment of plasma gas flow rate from 2.0 scfh to 1.0 scfh can considerably reduce the penetration capability and change the operation mode from keyhole to melt-in. It is technically possible to use an adjustable flow control valve, and the gas flow rate can be controlled by an external electrical signals. However, this flow rate control mechanism has a relatively large time delay compared with the needed pulse period of welding current. The valve reaction to the control signal and the flow rate change from the gas supply to the torch end both take time. Therefore, similar to torch configuration, the plasma gas flow rate is set to a level that just sufficient to for keyhole operation.

The welding current controls the penetration capability and heat input of plasma arc. With a reduced welding current, the heat input may become insufficient to achieve full penetration if a single melt-in mode is used. However, since the full penetration is almost achieved in the first stage, the establishment process for full penetration may still be able to continue and finish with the reduced heat input. This operation status is considered a quasi-melt-in mode. As an electrical parameter, the welding current can be easily adjusted by the control system in real-time. Therefore, the transition from keyhole to quasi-melt-in mode is switched by adjusting the welding current.

There are other welding conditions and parameters that also affect the penetration capability, such as coolant recirculation rate, overall torch size and rating, distribution of plasma gas, etc. However, in comparison with the parameters/variables aforementioned, their real-time adjustments are even more difficult. Hence, this invention switches from the keyhole mode to the melt-in mode by reducing the current from the first peak to a second peak.

### Mode Switch with a Second Electrode

When the peak current is changed from Iₚ₁ to Iₚ₂, an additional current may be provided into the work-piece by adding a second electrode. This current can provide sufficient heat input for the melt-in mode operation. To this end, a parallel circuit can be established as shown in FIG. 6. Because this added current is not constricted by the orifice of the plasma torch, the ability to penetrate the work-piece is not much increased by this added current. The penetration capability and heat input may thus be separately controlled. This would allow Iₚ₂ to be further reduced while the full penetration may still be established due to the controlled heat input.

### Torch Travel and Wire Filler

The welding torch can travel in a continuous mode or stepwise mode. In both modes, the optional arc length control and optional filler wire addition are implemented during the base period.

The stepwise mode torch motion is preferred. If the continuous travel model is used, the work-to-tungsten distance during the second peak current period must be minimized or the distance slope is added as additional information to analyze the vertex.

Further, the torch travel can be manual or mechanized/automated. The filler wire addition can be manual or mechanized/automated.

### ANALYSIS AND ADVANTAGES

PAW process gives different performances in keyhole and melt-in modes. For keyhole mode, highly constricted arc is capable of reaching full penetration rapidly. However, due to the high penetration capability, the weld bead produced with keyhole mode tends to have large back-side weld reinforcement (convexity on the backside bead). At the same time, there may be spatters blown out of the weld pool by the strong plasma jet. On the other hand, for melt-in mode, its moderate penetration capability resembles that of GTAW process, which is capable of generating smooth weld beads. However, the welding current needs to be increased considerably in order to produce full penetration on same joints. The melt-in mode thus can only be used to weld work-pieces with thickness much less than those can be welded with keyhole mode. In addition, since heat input is increased, the weld pool becomes larges and sometimes collapses may occur.

### Welds Made in Keyhole Mode

The weld beads produced by keyhole PAW are sensitive to a number of welding parameters including welding speed, welding current, flow rate and composition of plasma/shielding gas, electrode setback, torch standoff distance, etc. [7, 8]. Extensive studies have been conducted on keyhole PAW and effective methods have been proposed, implemented and tested for the control of keyhole PAW process[9-12]. With the control system developed in [13], welding parameters can be adjusted to generate consistent weld bead in the presence of various disturbances. Its principle is to pulse the welding current to intentionally produce a varying weld pool and associated varying arc voltage and then determine the weld penetration depth from the arc voltage measurements [14]. During the peak current period, the welding torch stays at the same spot to gain accurate measurement of arc length from the arc voltage signal and determine if the desired penetration has been achieved; during the low current base period, the torch moves for a certain fixed distance to the next spot and waits for the next pulsing control period.

To operate in keyhole mode, a relatively small orifice diameter is needed. A relatively large plasma gas flow rate is also needed to further enhance the penetration capability of the plasma jet. Then the full penetration can be obtained through the strong penetration capability of the plasma jet. The resultant weld beads on both sides are narrow (compared with GTAW). However, strong penetrating plasma jets also cause problems for keyhole mode. Full penetration is obtained by punching a hole with strong plasma jet inside the liquid weld pool such that a small portion of the melted metal inside the weld pool may be blown away as spatters. Immediately after welding, small particles of spatters were found inside the pipe. At the same time, solidified weld beads on the back-side of the work-piece exhibited geometrical irregularities and excessive convexities (over 2 mm reinforcement).

### Welds Made in Melt-in Mode

Melt-in mode PAW can be performed using a reduced penetration capability. To this end, the orifice diameter can be increased and the plasma gas flow rate can be reduced. Due to the weakened arc force, a larger heat input had to be used by increasing the welding current in order to achieve desired penetration. After these adjustments, the process could operate in melt-in mode and produce full penetration but it resembled the behavior of GTAW process.

With fine-tuned welding parameters, full penetration welds can be produced under melt-in mode. The weld bead is smooth without undercut and large convexity, similar to that made by GTAW process. The smooth weld bead meets visual inspection requirements. However, due to the weak penetration capability, full penetration can only be guaranteed in a small welding speed range, which makes it difficult for manual welding practice. Furthermore, the HAZ is large, because the weld penetration is achieved by conduction of heat under melt-in mode. The excessive heat input (compared with keyhole mode) generates a large weld pool, which may occasionally collapse.

### Heat Input Analysis

With experimental results in [15], comparisons were made for heat inputs delivered to the work-piece (net heat input) among GTAW process and three PAW process operation modes, i.e. keyhole, melt-in and double stage modes. A number of studies have been conducted to investigate the heat input and arc efficiency in arc welding processes [16-19]. For the double stage PAW in this invention, the primary objective is to produce full penetration with reduced net heat input. Arc efficiency gives a quantitative measurement of the fraction of total arc energy delivered to the work-piece. The total energy generated by the power supply can be easily calculated based on the arc voltage and welding current measurement. Referring to the arc efficiency results from [17], a general comparison is possible for PAW and GTAW process. A comparison has been made for welding of the exactly same pipes and listed in Table 1, i.e., Table 6 in [15].

TABLE 1
Comparison of net heat input in unit weld bead length

| | | | Double | |
|---|---|---|---|---|
| | Keyhole | Melt-in | Stage | |
| Welding Process | PAW | PAW | PAW | GTAW |
| Base period time (ms) | 800 | 600 | 800 | N/A |
| Base period current (A) | 20 | 30 | 20 | N/A |
| Base period voltage (V) | 18 | 19 | 18 | N/A |
| First stage peak period time (ms) | 250 | 350 | 200 | N/A |
| First stage peak period current (A) | 110 | 125 | 110 | N/A |
| First stage peak period voltage (V) | 25 | 26 | 25 | N/A |
| Second stage peak period time | N/A | N/A | 300 | N/A |
| (ms) | | | | |
| Second stage peak period current | N/A | N/A | 60 | N/A |
| (A) | | | | |
| Second stage peak period voltage | N/A | N/A | 21 | N/A |
| (V) | | | | |
| GTAW welding current (A) | N/A | N/A | N/A | 120 |
| GTAW arc voltage (V) | N/A | N/A | N/A | 17 |
| Travel speed (mm/s) | 1.22 | 1.22 | 1.22 | 1.22 |
| Total heat input (J/mm) | 999 | 2021 | 1246 | 1672 |
| Arc efficiency (%) | ~47 | ~47 | ~47 | ~67 |
| Net heat input (J/mm) | 470 | 950 | 586 | 1120 |
| Typical backside bead width (mm) | 3~4 | ~10 | 5~6 | 9~11 |

From net heat input data in this table, it can be clearly observed that the four processes under comparison can be divided into two groups. The one with the net heat input around 1,000 J/mm includes melt-in PAW and GTAW process. This explains why the melt-in PAW produces welds similar to those using GTAW process. Although the plasma arc voltage is larger under the same welding current, its net heat input delivered to the work-piece is comparable to that of the GTAW. Keyhole and double stage PAW processes are in the group with a net heat input around 500 J/mm. As a result, the weld beads with smaller backside width were produced. Compared with keyhole PAW mode, the double stage PAW does not increase the net heat input delivered in to the work-piece. The combination of two modes of PAW not only reduced net heat input (compared with melt-in mode), but also significantly improved the weld bead (compared with keyhole mode), with smaller backside reinforcement, moderate backside width and no spatters.

### REFERENCES

1. Pires, J. N., A. Loureiro, and G. Bolmsjo, Welding robots: technology, system issues and applications. 2006: Springer.
2. Jenney, C. L., A. O′Brien, and AWS, Welding handbook. 9th ed. 2001, Miami, Fla.: American Welding Society.
3. Messler, R. W., Principles of welding: processes, physics, chemistry, and metallurgy. 1999: John Wiley.
4. AWS, Welding Handbook. Vol 2. Welding Process. 1990: American Welding Society.
5. Martikainen, J., Conditions for achieving high-quality welds in the plasma-arc keyhole welding of structural steels. Journal of Materials Processing Technology, 1995. 52: p. 68-75.
6. Zhang, Y. M., Y. Ma, Stochastic modeling of plasma reflection during keyhole arc welding. Measurement Science and Technology, 2001. 12: p. 1964-1975.
7. The Procedure Handbook of Arc Welding. 1973: The Lincoln Electric Company.
8. Howard, B. C., Modern Welding Technology. 2nd ed. 1989, New Jersey: Prentice Hall.
9. Liu, Y. and Y. Zhang, Control of dynamic keyhole welding process. Automatica, 2007. 43: p. 876-884.
10. Zhang, Y. and Y. Liu, Modeling and control of quasi-keyhole arc welding process. Control Engineering Practice, 2003. 11: p. 1401-1411.
11. Lu, W., W. Y. Lin, and Y. M. Zhang, Nonlinear interval model control of quasi-keyhole arc welding process. Automatica, 2004. 40: p. 805-813.
12. Zhang, Y., Y. Ma, Stochastic modeling of plasma reflection during keyhole arc welding. Measurement Science and Technology, 2001. 12: p. 1964-1975.
13. Li, X., Model Predictive Control over Manual Pipe Welding Process on Stainless Steel, in Electrical Engineering. 2010, University of Kentucky: Lexington. p. 91-118.
14. Li, X., et al., Manual Keyhole PAW with Application. Welding Journal, 2011. 90(12): p. 258s-264s.
15. Li, X., Z. Shao, and Y. Zhang, Double stage plasma arc welding process. Welding Journal, 2012. 91(12).
16. Fuerschbach, P. W. and G. A. Knorovsky, A Study of Melting Efficiency in Plasma Arc and Gas Tungsten Arc Welding. Welding Journal, 1991. 70(11): p. 287-297.
17. DuPont, J. N. and A. R. Marder, Thermal efficiency of arc welding processes. Welding Journal, 1995. 74(12): p. 406-416.
18. Giedt, W. H., L. N. Tallerico, and P. W. Fuerschbach, GTA welding efficiency: calorimetric and temperature field measurements. Welding Journal, 1989. 68(1): p. 28-32.
19. Berezovskii, B. M., The thermal efficiency of the process of penetrating metals with a welding arc at the surface. Automatic Welding, 1979. 10: p. 18-21.

What is claimed is:

1. A method to plasma arc weld comprising:
a base current period in which the plasma arc welding current is relatively low;
a first peak current period that follows the base current period and in which the plasma arc welding current is high;
a second peak current period that follows the first peak period and in which the plasma arc welding current is reduced from that in the first peak period;
a judgment which determines if the full penetration has been established;
a switch from the second peak to the base period to continue the next welding cycle if the judgment says that the full penetration has been established.

2. The method in claim 1 wherein the judgment on the establishment of the full penetration is made using feedback from the process.

3. The method in claim 1 wherein the judgment on the establishment of the full penetration is made using the measured plasma arc voltage.

4. A method to judge the establishment of the full penetration using the measured plasma arc voltage in the method to plasma arc in claim 1 comprising
a means to read the plasma arc voltage into the computer including an embedded system;
a method to process the plasma arc voltage;
a criterion to determine the establishment of the full penetration from the processed plasma arc voltage signal

5. The method in claim 4 wherein the plasma arc voltage measurements are processed by fitting a model to calculate the slope of the plasma arc voltage signal

6. The method in claim 4 wherein the judgment for the full penetration is made by comparing the model calculated voltage slope with a pre-specified small non negative value.

7. A modified method to plasma arc weld comprising
the use of an added second electrode that can form an unconstructed free arc with the work-piece in parallel with the constrained plasma arc;
a base current period in which the plasma arc welding current is relatively low;
a first peak current period that follows the base current period and in which the plasma arc welding current is high;
a second peak current period that follows the first peak period and in which the plasma arc welding current is reduced from that in the first peak period or reduced to zero and the unconstrained arc current is no-zero;
a judgment which determines if the full penetration has been established;
a switch from the second peak to the base period to continue the next welding cycle if the judgment says that the full penetration has been established.
a judgment which determines if the full penetration has been established;
a switch from the second peak to the base period to continue the next welding cycle if the judgment says that the full penetration has been established.

8. The modified method in claim 7 wherein the judgment on the establishment of the full penetration is made using feedback from the process.

9. The modified method in claim 7 wherein the judgment on the establishment of the full penetration is made using the measured plasma arc voltage.

10. A method to judge the establishment of the full penetration using the measured plasma arc voltage in the modified method for PAW in claim 7 comprising
a means to read the plasma arc voltage into the computer including an embedded system;
a method to process the plasma arc voltage;
a criterion to determine the establishment of the full penetration from the processed plasma arc voltage signal.

11. The method in claim 10 wherein the plasma arc voltage measurements are processed by fitting a model to calculate the slope of the plasma arc voltage signal.

12. The method in claim 10 wherein the judgment for the full penetration is made by comparing the model calculated plasma arc voltage slope with a pre-specified small non negative value.

13. A method to move the torch when implementing the method in claim 1 using a mechanism to
hold the torch;
move the torch;
stop the torch;
control the torch speed.

14. In claim 13 wherein the mechanism is a human.

15. In claim 13 wherein the mechanism is a mechanized device.

16. In claim 13 wherein the mechanism moves the torch continuously.

17. In claim 13 wherein the mechanism stops the torch during the first and second peak periods and moves the torch in the base period.

18. A method to operate the optional filler wire when implementing the method in claim 1
using a mechanism to
hold the wire;
feed the wire;
stop the wire feeding;
retract the wire;
control the wire feeding speed.

19. In claim 18 wherein the mechanism is a human.

20. In claim 18 wherein the mechanism is a mechanized device.

21. In claim 18 wherein the mechanism feeds the wire into the weld pool continuously.

22. In claim 18 wherein the mechanism stops the wire feeding during the first and second peak periods and feed the wire in the base period.
